(19) United States
(12) Patent Application Publication
(10) Pub. No.: US 2011/0216331 A1
(43) Pub. Date: Sep. 8, 2011

(54) IMAGE FORMING APPARATUS AND CONTROL METHOD OF THE SAME

(75) Inventor: Keita Umeda, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/039,591

(22) Filed: Mar. 3, 2011

Related U.S. Application Data
(60) Provisional application No. 61/310,971, filed on Mar. 5, 2010.

(51) Int. Cl. G06K 15/02

(52) U.S. Cl. 358/1.2

(57) ABSTRACT

According to one embodiment of the invention, an image processor generates a median filter circuit and median-filters input image data.

### CROSS-REFERENCE TO RELATED APPLICATIONS

This application is based upon and claims the benefit of priority from U.S. provisional applications 61/310,971, filed on Mar. 5, 2010, the entire contents of which are incorporated herein by reference.

### FIELD

Embodiments described herein relate generally to an image forming apparatus and a control method of the same.

### BACKGROUND

An image forming apparatus prints image data obtained by scanning an original document or image data input from an external device (for example, a personal computer) connected thereto via a network on a sheet of paper or compresses and stores the image data in a small size.

In such an image forming apparatus, it is desirable to print or store an image without noise.

### BRIEF DESCRIPTION OF THE DRAWINGS

FIG. 1 is a block diagram illustrating the configuration of a control circuit according to an embodiment of the invention.

FIG. 2 is a flow diagram illustrating the operation according to an embodiment of the invention.

### DETAILED DESCRIPTION

In general, according to one embodiment of the invention, there is provided an image forming apparatus including: an image processor which can selectively generate a median filter circuit median-filtering input image data, a low-resolution conversion circuit converting the resolution of the image data median-filtered by the median filter circuit into a low resolution, and an edge detecting circuit detecting an edge of a character image area in the image data processed by the low-resolution conversion circuit; and a controller which generates the median filter circuit and starts its process, generates the low-resolution conversion circuit and starts its process after the process of the median filter circuit is ended, generates the edge detecting circuit and starts its process after the process of the low-resolution conversion circuit is ended, separates the image data processed by the edge detecting circuit into character image data and background image data by analyzing the layout of the character image area in the image data processed by the edge detecting circuit after the process of the edge detecting circuit is ended, compresses the separated character image data and the separated background image data, and files the compressed character image data and the compressed background image data into a file.

Hereinafter, an embodiment of the invention will be described with reference to the accompanying drawings.

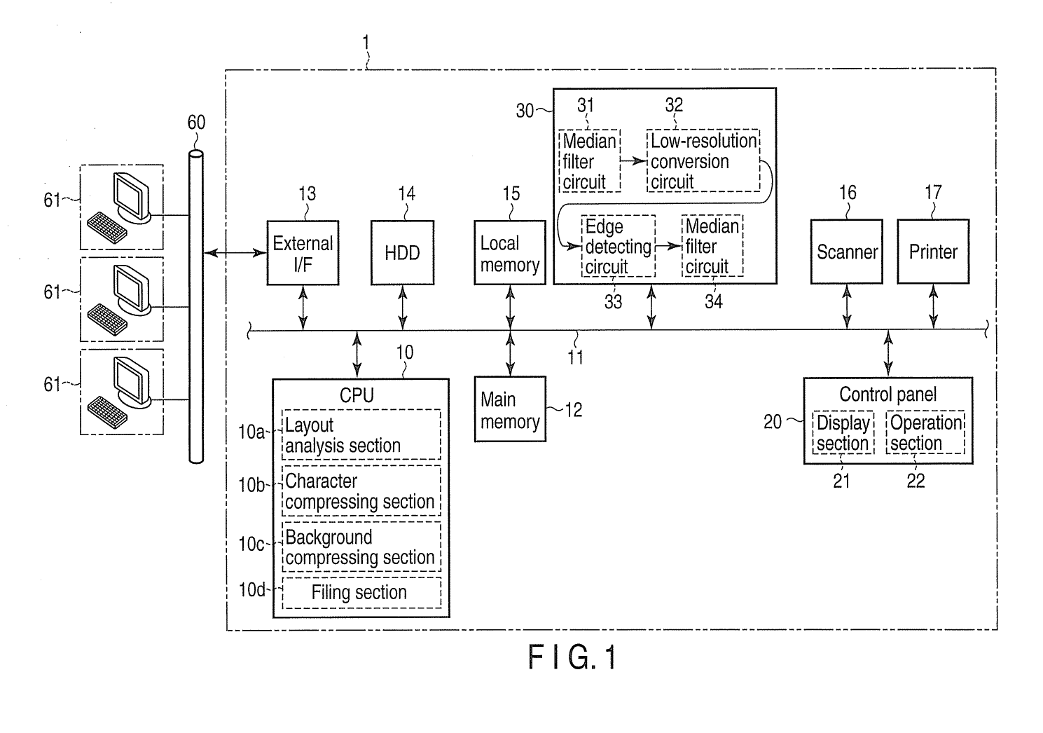

In FIG. 1, reference numeral 1 represents a complex image forming apparatus, that is, a so-called an MFP (Multi Function Peripheral) and has plural functions such as a copier function, a scanner function, and a printer function. The MFP 1 includes a CPU 10 serving as a controller. The CPU 10 is connected to a bus 11. The bus 11 is connected to a main memory 12 as a storage section, an external interface 13, a hard disk drive (HDD) 14 as a storage section, a local memory 15 as a storage section, a scanner 16, a printer 17, a control panel 20, and an image processor 30.

The local memory 15 serves to temporarily store image data which is processed by the image processor 30. The scanner 16 optically reads an image of an original document set up in the MFP 1. The printer 17 prints the image data on a sheet of paper. The control panel 20 serves to allow a user to set operating conditions and includes a display section 21 and an operation section 22.

Plural client terminals, for example, plural personal computers 61, are connected to the external interface 13 via a network cable 60. The personal computers 61 generate image data by the use of various built-in application programs (such as a word processor, a table calculator, a presentation program, and DTP software) and send the generated image data to the MFP 1.

The image processor 30 is, for example, a dynamic reconfigurable processor and can selectively generate a median filter circuit 31, a low-resolution conversion circuit 32, an edge detecting circuit 33, and a median filter circuit 34.

The median filter circuit 31 median-filters an input image. The median-filtering is a process of arranging concentration levels of pixels in a local area including n×n pixels in an order of magnitude and replacing the concentration level of the pixel located at the center of the local area with the concentration level located at the center of the arrangement. The particle-like noise, that is, so-called roughness, on an image is removed by the median-filtering. The median-filtering is well known. A condition that only the pixels having a concentration level equal to or greater than a predetermined threshold are treated as a processing target is set for the median-filtering. The deterioration of a thin line or character is prevented by setting this condition.

The low-resolution conversion circuit 32 converts the resolution of the image data median-filtered by the median filter circuit 31 into a low resolution. The edge detecting circuit 33 detects the edge of a character image area in the image data processed by the low-resolution conversion circuit 32. The median filter circuit 34 median-filters background image data separated by a layout analysis section 10a to be described later. The median-filtering of the median filter circuit 34 is the same as the median-filtering of the median filter circuit 31.

The image processor 30 of the CPU 10 generates the median filter circuit 31 and starts its process, generates the low-resolution conversion circuit 32 and starts its process after the process of the median filter circuit 31 is ended, generates the edge detecting circuit 33 and starts its process after the process of the low-resolution conversion circuit 32 is ended, separates the image data processed by the edge detecting circuit 33 into character image data and background image data by analyzing the layout of the character image area in the image data processed by the edge detecting circuit 33 after the process of the edge detecting circuit 33 is ended, compresses the separated character image data after the analysis and the separation, generates the median filter circuit 34 and starts its median-filtering process, compresses the background image data median-filtered, and files the compressed character image data and the compressed background image data into a file, for example, a PDF file. That is, the CPU 10 includes a layout analysis section 10a that performs the analysis and the separation, a character compressing section 10b that compresses the character image data separated by the layout analysis section 10a, a background compressing section 10c that compresses the background image data median-filtered by the median filter circuit 34, and a filing section 10d that files the character image data compressed by the character compressing section 10b and the background image data compressed by the background compressing section 10c into a PDF file.

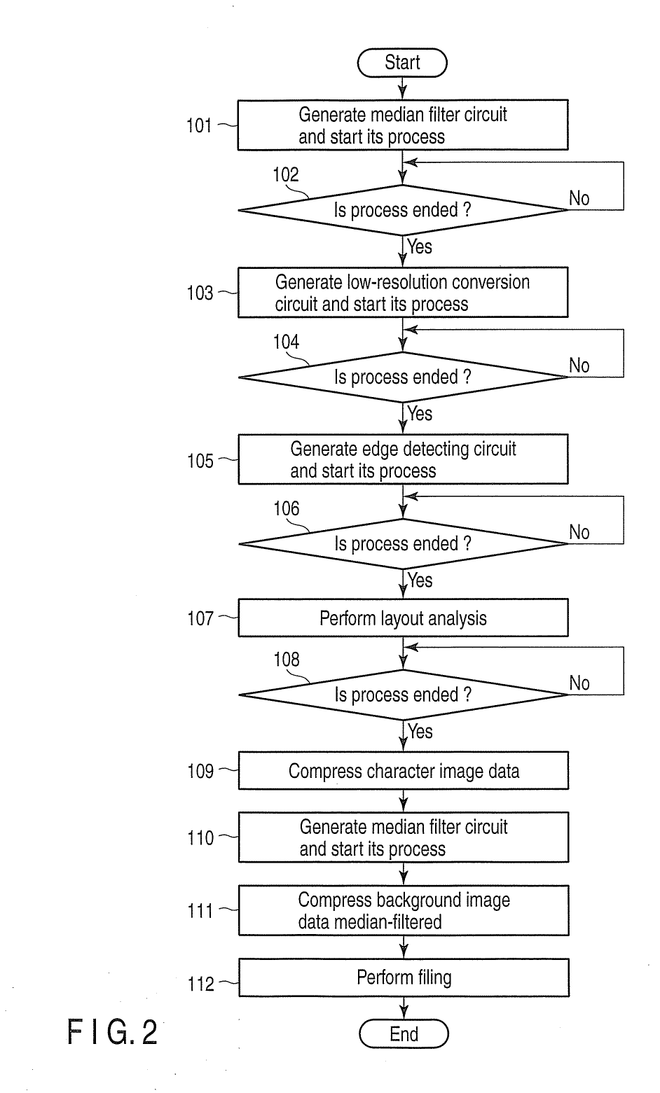

The operation will be described with reference to the flow diagram shown in FIG. 2.

When image data is input from the scanner 16 or the personal computers 61, the image processor 30 of the CPU 10 generates the median filter circuit 31 and starts its process (Act 101). When the process of the median filter circuit 31 is ended (YES in Act 102), the image processor 30 of the CPU 10 generates the low-resolution conversion circuit 32 instead of the median filter circuit 31 and starts the process of the low-resolution conversion circuit 32 (Act 103). When the process of the low-resolution conversion circuit 32 is ended (YES in Act 104), the image processor 30 of the CPU 10 generates the edge detecting circuit 33 instead of the low-resolution conversion circuit 32 and starts the process of the edge detecting circuit 33 (Act 105).

When the process of the edge detecting circuit 33 is ended (YES in Act 106), the CPU 10 separates the image data processed by the edge detecting circuit 33 into character image data and background image data by analyzing the layout of the character image area in the image data processed by the edge detecting circuit 33 (Act 107). After the analysis and the separation are performed (YES in Act 108), the CPU 10 compresses the separated character image data (Act 109), and the image processing processor 30 generates the median filter circuit 34 instead of the edge detecting circuit 33 and starts the process of the median filter circuit 34 (Act 110). That is, the separated background image data is median-filtered. The CPU 10 compresses the median-filtered background image data (Act 111). The CPU 10 files the compressed character image data and the compressed background image data into a PDF file (Act 112). The PDF file is stored in the main memory 12 and is then stored, for example, in the hard disk drive 14.

In this way, since the image processor 30 generates the median filter circuit 31 and median-filters the input image data, it is possible to remove the particle-like noise, that is, the roughness, on an image. Since the image processor 30 generates the median filter circuit 34 and median-filters the background image data separated through the layout analysis, it is possible to more efficiently remove the roughness on the background image.

Since one image processor 30 selectively generates plural circuits, it is possible to simplify the configuration and to reduce the cost, compared with the configuration where fixed hardware such as an ASIC having plural circuits individually arranged therein is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image processor which can selectively generate a median filter circuit median-filtering input image data, a low-resolution conversion circuit converting the resolution of the image data median-filtered by the median filter circuit into a low resolution, and an edge detecting circuit detecting an edge of a character image area in the image data processed by the low-resolution conversion circuit; and
a controller which generates the median filter circuit and starts its process, generates the low-resolution conversion circuit and starts its process after the process of the median filter circuit is ended, generates the edge detecting circuit and starts its process after the process of the low-resolution conversion circuit is ended, separates the image data processed by the edge detecting circuit into character image data and background image data by analyzing the layout of the character image area in the image data processed by the edge detecting circuit after the process of the edge detecting circuit is ended, compresses the separated character image data and the separated background image data, and files the compressed character image data and the compressed background image data into a file.

2. The apparatus of claim 1, wherein the controller includes:
a layout analysis section which separates the image data processed by the edge detecting circuit into character image data and background image data by analyzing the layout of the character image area in the image data processed by the edge detecting circuit after the process of the edge detecting circuit is ended;
a compressing section which compresses the character image data and the background image data separated by the layout analysis section; and
a filing section which files the character image data and the background image data compressed by the compressing section into a file.

3. The apparatus of claim 1, wherein the image processor can selectively generate the median filter circuit, the low-resolution conversion circuit, the edge detecting circuit, and a second median filter circuit which median-filters the separated background image data.

4. The apparatus of claim 3, wherein the controller generates the median filter circuit and starts its process, generates the low-resolution conversion circuit and starts its process after the process of the median filter circuit is ended, generates the edge detecting circuit and starts its process after the process of the low-resolution conversion circuit is ended, separates the image data processed by the edge detecting circuit into character image data and background image data by analyzing the layout of the character image area in the image data processed by the edge detecting circuit after the process of the edge detecting circuit is ended, generates the second median filter circuit and starts its process after the separation, compresses the separated character image data, compresses the background image data median-filtered by the second median filter circuit, and files the compressed character image data and the compressed background image data into a file.

5. The apparatus of claim 4, wherein the controller includes:
a layout analysis section which separates the image data processed by the edge detecting circuit into character image data and background image data by analyzing the layout of the character image area in the image data processed by the edge detecting circuit after the process of the edge detecting circuit is ended;
a character compressing section which compresses the character image data separated by the layout analysis section;
a background compressing section which compresses the background image data median-filtered by the second median filter circuit; and
a filing section which files the character image data compressed by the character compressing section and the background image data compressed by the background compressing section into a file.

6. The apparatus of claim 1, wherein the image processor is a dynamic reconfigurable processor.

7. The apparatus of claim 1, further comprising a storage section which stores the file filed by the filing.

8. A control method of an image forming apparatus having an image processor which can selectively generate a median filter circuit median-filtering input image data, a low-resolution conversion circuit converting the resolution of the image data median-filtered by the median filter circuit into a low resolution, and an edge detecting circuit detecting an edge of a character image area in the image data processed by the low-resolution conversion circuit, the method comprising:
generating the median filter circuit and starting its process;
generating the low-resolution conversion circuit and starting its process after the process of the median filter circuit is ended;
generating the edge detecting circuit and starting its process after the process of the low-resolution conversion circuit is ended;
separating the image data processed by the edge detecting circuit into character image data and background image data by analyzing the layout of the character image area in the image data processed by the edge detecting circuit after the process of the edge detecting circuit is ended;
compressing the separated character image data and the separated background image data; and
filing the compressed character image data and the compressed background image data into a file.

9. The method of claim 8, wherein the image processor can selectively generate the median filter circuit, the low-resolution conversion circuit, the edge detecting circuit, and a second median filter circuit which median-filters the separated background image data.

10. The method of claim 8, wherein the image processor is a dynamic reconfigurable processor.
